(19) United States
(12) Patent Application Publication
(10) Pub. No.: US 2023/0268577 A1
(43) Pub. Date: Aug. 24, 2023

(54) MOTOR VEHICLE WITH A TRACTION BATTERY

(71) Applicant: Dr. Ing. h.c. F. Porsche Aktiengesellschaft, Stuttgart (DE)

(72) Inventors: Manuel Groß, Hessigheim (DE); Christoph Siegmund Bara, Prag (CZ); Domenica Fresca, Renningen-Malmsheim (DE); Jens Niewöhner, Wiernsheim (DE); Patrick Böhl, Wendlingen am Neckar (DE); Marcel Straub, Kornwestheim (DE); Stefano Ruberto, Leonberg (DE)

(73) Assignee: Dr. Ing. h.c. F. Porsche Aktiengesellschaft, Stuttgart (DE)

(21) Appl. No.: 18/112,579

(22) Filed: Feb. 22, 2023

(30) Foreign Application Priority Data
Feb. 23, 2022 (DE) 10 2022 104 236.7

(51) Int. Cl. H01M 10/625; B60K 1/04; B60L 58/26

(52) U.S. Cl. CPC H01M 10/625; B60K 1/04; B60L 58/26; H01M 2220/20; B60K 2001/0438

(57) ABSTRACT

A motor vehicle having a traction battery accommodated in a motor vehicle body. The traction battery is configured for an electric drive. A cooling system is provided for cooling the electric drive. An underbody element of an underbody of the vehicle body includes a passage opening, which can be opened or closed with the aid of a closing element. The underbody element is provided for the purpose of cooling the traction battery.

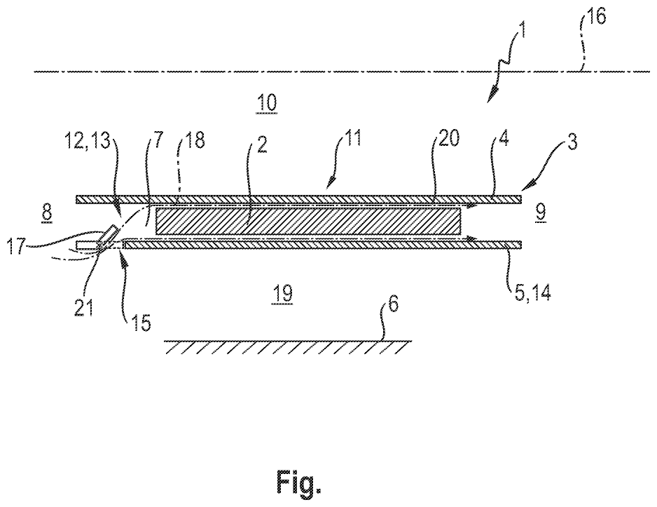

### CROSS-REFERENCE TO RELATED APPLICATION

This application claims priority to German Patent Application No. 10 2022 104 236.7, filed Feb. 23, 2022, the content of such application being incorporated by reference herein in its entirety.

### FIELD OF THE INVENTION

The invention relates to a motor vehicle having a traction battery.

### BACKGROUND OF THE INVENTION

Motor vehicles having traction batteries are known. Typically, the motor vehicle comprises an electric drive in the form of an electric motor, which is powered by the traction battery. For example, the traction battery comprises an energy storage unit in the form of a plurality of battery modules comprising a plurality of battery cells. The plurality of battery cells are bundled so as to form a battery module, wherein a plurality of battery modules are accommodated in a battery housing of the traction battery. The traction battery is accommodated in a receiving space of a body of the motor vehicle. Typically, the traction battery and the electric motor, both of which include heat generation in their operation, are temperature-controlled using a cooling system.

In motor vehicles that have an electric drive and thus can be referred to as battery-electrically driven vehicles, the traction battery is constantly under load during operation of the motor vehicle, whereby it heats up. In order to ensure secure operation of the drive components at all temperatures, the cooling system is provided.

In order to be operated, the cooling system of the traction battery requires power that is generated by the traction battery itself. It follows that a lower energy requirement for heating or cooling the traction battery directly corresponds to an increase in the available energy for operating the motor vehicle. Or, in other words, a lower demand for energy for heating or cooling the traction battery leads to a greater mileage of the motor vehicle.

DE 10 2019 001 391 A1, which is incorporated by reference herein, discloses an electric vehicle having an underbody traction battery, wherein an air inlet opening that can be adjusted by an adjustable control valve is provided in the front region of the electric vehicle. The airflow entering through the air inlet opening is used in order to cool the underbody traction battery.

An electric vehicle having a traction battery arranged on the underbody can be found in DE 2016 210 266 A1, which is incorporated by reference herein. The traction battery is completely delimited from a driving terrain with the aid of a bottom plate in order to produce an air-insulating layer for insulation of the traction battery. With the aid of valves, a circulation of the air can be produced, wherein the valves are above the bottom plate when viewed in the direction of a vertical axis of the electric vehicle.

A motor vehicle having a passenger cabin and a battery is known from DE 10 2011 018 553 A1, which is incorporated by reference herein, wherein the passenger cabin and the battery are connected to a first, permanently opened air inlet opening, and the battery is additionally fluidly connected to a second air inlet opening that is controllable by a valve.

EP 2 199 133 B1, which is incorporated by reference herein, discloses a hybrid vehicle having an underbody battery, wherein an airflow is guided over a box profile body to the underbody battery for cooling the underbody battery, wherein the airflow can be adjusted by an adjustment valve.

### SUMMARY OF THE INVENTION

A motor vehicle according to aspects of the invention comprises a traction battery that is accommodated in a motor vehicle body having a shell and an underbody. The traction battery is configured for an electric drive. A cooling system is provided for cooling the electric drive. According to the invention, for cooling the traction battery, an underbody element of the underbody comprises a passage opening, which can be opened or closed with the aid of a closing element. Thus, by opening the passage opening, a cooling of the traction battery can be brought about in a simple manner with the aid of convection, because air can flow above the underbody through the opened passage opening and thus into the motor vehicle body in which the traction battery is accommodated. Thus, the cooling of the traction battery can be supplemented by the cooling with the aid of convection so that the energy expended by the traction battery to cool itself can be reduced.

Preferably, the closing element is controllable so that the cooling can be actively produced by way of convection. With the aid of the controllable closing element on the underbody, waste heat can be convectively discharged from the traction battery during a journey, and cooling capacity can thus be saved. Of course, the closing element could also be, for example, self-regulating, for example in the form of a check valve, which brings about an opening or closing of the passage opening with the aid of a negative pressure, however, a secure cooling is then not realized, in particular in a case where the traction battery is required.

Advantageously, the closing element is configured in the form of a valve, wherein the closing element is in particular configured in the form of a pivotably mounted valve, which is preferably arranged pivotably on the underbody.

Preferably, the traction battery is accommodated in a cavity formed between the shell and the underbody.

In order to realize an air cushion insulation between the traction battery and the shell and/or the underbody, an air gap is formed between the traction battery and the shell and/or the underbody. Thus, when the motor vehicle is idling, the air between the shell and/or the underbody can serve as an insulation, and, when the vehicle is in operation, in particular when an air gap is formed between the underbody and the shell, the air can flow around the traction battery, at least up and down when viewed in the direction of a vertical axis of the motor vehicle body, in order to bring about a preferred convection cooling. An insulating effect while idling reduces an influence of the environment, i.e., a cooling or heating via the shell.

The passage opening can be arranged upstream and/or downstream in the direction of travel and/or in a region of the underbody element covered by the traction battery. In other words, it does not necessarily have to be arranged upstream of the traction battery, i.e., in front of the traction battery in the direction of flow, wherein this is however the preferred variant of the positionings of the passage opening since the air can flow here without further assistance and directly onto the traction battery in the direction opposite the direction of travel.

Preferably, the closing element is configured with a National Advisory Committee for Aeronautics (NACA) airfoil so that an aerodynamic performance of the motor vehicle is not influenced, or at least not significantly influenced, by the closing element.

Overall, a motor vehicle having a traction battery is thus realized, which shows an increase in an effective electrical mileage since a portion of the necessary cooling capacity is replaced by the measures described above.

### BRIEF DESCRIPTION OF THE DRAWING

Additional advantages, features, and details of the invention arise from the following description of preferred exemplary embodiments with reference to the drawing. The features and combinations of features mentioned above in the description and the features and combinations of features mentioned below in the description of the figures and/or shown only in the FIGURE can be used not only in the respectively indicated combination but also in other combinations or on their own without departing from the scope of the invention.

The sole FIGURE shows, in a principle view, a motor vehicle according to the invention having a traction battery.

### DETAILED DESCRIPTION OF THE INVENTION

A motor vehicle 1 according to the invention comprises a traction battery 2, which is configured so as to drive an electric motor, which is not shown in further detail. The motor vehicle 1 comprises a motor vehicle body 3, which has a shell 4 and an underbody 5, wherein the underbody 5 at least partially delimits the shell 4 with respect to a driving terrain 6. A cavity 7 is formed between the shell 4 and the underbody 5, in which cavity the traction battery 2 is arranged. In the present exemplary embodiment, the cavity 7 is formed between a front 8 of the motor vehicle body 3 and a rear 9 of the motor vehicle body 3 in a so-called central region 10 of the motor vehicle body 3. The central region 10 is in the region of a passenger compartment of the motor vehicle body 3.

The traction battery 2 is configured so as to supply power to the electric motor. It comprises a battery module having a plurality of battery cells and is fixedly connected to the motor vehicle body 2.

In order to cool an electric drive 11 comprising the traction battery 2 and the electric motor, a cooling system 12 is configured with a cooling circuit 13, wherein the cooling circuit 13 can comprise two partial circuits configured independently of one another, so that the traction battery 2 can be cooled independently of the electric motor, and vice versa. The cooling circuit 13 can be guided through the shell 4 in order to use the shell 4 as a heat sink.

According to the invention, the motor vehicle body 3 of the motor vehicle 1 configured in the form of an electric vehicle comprises, on an underbody element 14 of the underbody 5, a passage opening 15 through which air can flow into the cavity 7.

In the present exemplary embodiment, the passage opening 15 is formed upstream of the traction battery 2 in the direction of a longitudinal axis 16 of the motor vehicle body 3 and, when viewed in the direction of travel. It could also be arranged downstream of the traction battery 2 or in a region of the underbody element 14 covered by the traction battery 2. The air flows into the cavity 7 via the passage opening 15 and can flow around the traction battery 2 for cooling via convection.

In order to control the cooling of the traction battery 2 with the aid of the air flowing through the passage opening 15, the passage opening 15 can be closed with a closing element 17, which is preferably configured in the form of a valve. It could also be in the form of a sliding element or a completely closable aperture, but the closing element 17 configured in the form of the valve has the advantage of an air guide, as can be seen in the FIGURE with the aid of the airflow lines 18. Preferably, the closing element 17, provided it is in the form of a valve, is configured so as to open toward the shell 4 and is pivotably attached to the underbody element 14 about a pivot axis 21.

If the closing element 17 is positioned to be completely closing the passage opening 15, the air flows along on the underbody 5 between the underbody 5 and the driving terrain 6 without entering the cavity 7. However, if the closing element 17 is positioned to be partially or completely closing the passage opening 15, the air can flow into the cavity 7 via the passage opening 15 and flow around the traction battery 2 for heat discharge.

The closing element 17 is preferably opened during driving operation of the motor vehicle 1 since, in this state of the motor vehicle 1, a preferred inflow of air into the cavity 7 can be achieved.

The air could be delivered to an environment 19 downstream of the traction battery 2 via a further opening not shown in further detail.

Furthermore, with the aid of an air gap 21 which is formed between the shell 4 and the traction battery 2 and configured to preferably completely flow around the traction battery 2, the possibility is realized of forming, in particular in the idling state of the motor vehicle 1, an air cushion that acts as insulation from the shell 4. Furthermore, the air gap 21 is also present between the underbody element 14 and the traction battery 2. The insulating effect while idling reduces an influence of the environment 19 with respect to a cooling or heating via the shell 4.

In a further exemplary embodiment, which is not shown in further detail, the closing element 17 has an aerodynamic profile in the form of an airfoil, in particular in the form of a so-called NACA airfoil, so that, especially when the passage opening 15 is opened, an air resistance of the motor vehicle body 3 is not negatively influenced, or in other words increased or at least not significantly increased.

According to one aspect, the closing element 17 is a hinged or sliding door that is moved by a motor or solenoid that is also electrically connected to a computer having a processor, controller and/or software instructions for moving the closing element between open/closed positions. Movement of the closing element may be performed by the computer in response to temperature readings received from a temperature sensor, which measures a temperature of the traction battery, that is also connected to the computer.

### LIST OF REFERENCE SIGNS

1 Motor vehicle
2 Traction battery
3 Motor vehicle body
4 Shell
5 Underbody
6 Driving terrain
7 Cavity
8 Front
9 Rear
10 Central region
11 Electric drive
12 Cooling system
13 Cooling circuit
14 Underbody element
15 Passage opening
16 Longitudinal axis
17 Closing element
18 Airflow line
19 Environment
20 Air gap
21 Pivot axis

What is claimed is:

1. A motor vehicle comprising:
a motor vehicle body including a shell and an underbody;
a traction battery arranged in the motor vehicle body, wherein the traction battery is configured to power an electric drive of the motor vehicle;
a cooling system for cooling the electric drive; and
an underbody element of the underbody for cooling the traction battery, wherein the underbody element comprises a passage opening that is configured to be either opened or closed with the aid of a closing element.

2. The motor vehicle according to claim 1, wherein the closing element is configured to be controlled.

3. The motor vehicle according to claim 1, wherein the closing element is a valve.

4. The motor vehicle according to claim 1, wherein the closing element is a pivotably mounted valve.

5. The motor vehicle according to claim 4, wherein the closing element is pivotably arranged on the underbody.

6. The motor vehicle according to claim 1, wherein the traction battery is accommodated in a cavity formed between the shell and the underbody.

7. The motor vehicle according to claim 1, wherein an air gap is disposed between the traction battery and the shell.

8. The motor vehicle according to claim 1, wherein an air gap is disposed between the traction battery and the underbody.

9. The motor vehicle according to claim 1, wherein the passage opening is arranged upstream and/or downstream in a direction of travel of the motor vehicle and/or in a region of the underbody element covered by the traction battery.

10. The motor vehicle according to claim 1, wherein the closing element is a NACA airfoil.
